(19) United States
(12) Patent Application Publication
(10) Pub. No.: US 2022/0317536 A1
(43) Pub. Date: Oct. 6, 2022

(54) METHODS OF MANUFACTURING NANOCRYSTAL THIN FILMS AND ELECTROCHROMIC DEVICES CONTAINING NANOCRYSTAL THIN FILMS

(71) Applicant: HELIOTROPE EUROPE S.L., Bilbao (ES)

(72) Inventors: Guillermo GARCIA, Oakland, CA (US); Le Sheng Nicholas YIU, Alameda, CA (US); Hai WANG, Dublin, CA (US); Bonil KOO, Walnut Creek, CA (US); Liam RUSSELL, Alameda, CA (US); Megan GENTES, Alameda, CA (US)

(21) Appl. No.: 17/807,792

(22) Filed: Jun. 20, 2022

Related U.S. Application Data
(63) Continuation-in-part of application No. 16/428,111, filed on May 31, 2019.
(60) Provisional application No. 62/679,211, filed on Jun. 1, 2018.

(51) Int. Cl. G02F 1/155

(52) U.S. Cl. CPC G02F 1/155

(57) ABSTRACT

A method of forming a nanocrystal thin film (NTF) and an electrochromic (EC) device including the NTF, the method including depositing a precursor solution on a substrate to form a precursor layer, and annealing the precursor layer to form the NTF on the substrate. The precursor solution includes metal oxide nanoparticles, a solvent, and C8 or lower capping ligands bound to the metal oxide nanoparticles.

### CROSS REFERENCE TO RELATED APPLICATION

This application is a continuation application of U.S. application Ser. No. 16/428,111, filed on May 31, 2019, which claims the benefit of priority to U.S. Provisional Application Ser. No. 62/679,211, filed Jun. 1, 2018, the entire content of the foregoing applications are incorporated herein by reference.

### FIELD

The present invention is generally directed to a method of forming nanocrystal thin films, and electrochromic (EC) devices including such thin films.

### BACKGROUND OF THE INVENTION

Residential and commercial buildings represent a prime opportunity to improve energy efficiency and sustainability in the United States. The buildings sector alone accounts for 40% of the United States' yearly energy consumption (40 quadrillion BTUs, or “quads”, out of 100 total), and 8% of the world's energy use. Lighting and thermal management each represent about 30% of the energy used within a typical building, which corresponds to around twelve quads each of yearly energy consumption in the US. Windows cover an estimated area of about 2,500 square km in the US and are a critical component of building energy efficiency as they strongly affect the amount of natural light and solar gain that enters a building. Recent progress has been made toward improving window energy efficiency through the use of inexpensive static coatings that either retain heat in cold climates (low emissive films) or reject solar heat gain in warm climates (near-infrared rejection films).

Currently, static window coatings can be manufactured at relatively low cost. However, these window coatings are static and not well suited for locations with varying climates. A window including an electrochromic (EC) device overcomes these limitations by enhancing window performance in all climates.

### SUMMARY

According to an embodiment, a method of forming a nanocrystal thin film (NTF) comprises depositing a precursor solution on a substrate to form a precursor layer, and annealing the precursor layer to form a NTF on the substrate. The precursor solution includes: metal oxide nanoparticles; a solvent; and C8 or lower capping ligands bound to the metal oxide nanoparticles.

According to another embodiment, a method comprises providing a precursor solution comprising a solvent and metal oxide nanoparticles having C12 or higher capping ligands bound thereto, and exchanging C12 or higher capping ligands bound to the metal oxide nanoparticles for the C8 or lower capping ligands bound to the metal oxide nanoparticles.

### BRIEF DESCRIPTION OF THE DRAWINGS

FIG. 1 is a block diagram of a method of forming a NTF, according to various embodiments of the present disclosure.

FIGS. 2A and 2B are flow diagrams illustrating methods of forming precursor solutions, according to various embodiments of the present disclosure.

FIGS. 3A to 3D are schematic representations of EC devices according to various embodiments of the present disclosure.

### DETAILED DESCRIPTION OF THE EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being disposed “on” or “connected to” another element or layer, it can be directly on or directly connected to the other element or layer, or intervening elements or layers may be present. In contrast, when an element is referred to as being disposed “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Ranges can be expressed herein as from “about” one particular value, and/or to “about” another particular value. When such a range is expressed, examples include from the one particular value and/or to the other particular value. Similarly, when values are expressed as approximations, by use of the antecedent “about” or “substantially” it will be understood that the particular value forms another aspect. In some embodiments, a value of “about X” may include values of +/−1% X. It will be further understood that the endpoints of each of the ranges are significant both in relation to the other endpoint, and independently of the other endpoint.

A variety of optoelectronic devices, such as electrochromic (EC) devices, solar cells, display devices, and the like include nanocrystal thin films (NTFs). For example, NTFs may be utilized as transparent conductive layers and/or electrochromic layers in such devices. NTFs can be formed by various methods, such as vapor deposition, solution deposition, or the like.

With respect to solution deposition, a precursor solution or ink is coated or printed on a substrate to form a precursor layer. The precursor layer is then followed by a thermal process, such as a thermal anneal, is applied to the precursor layer, to drive off an organic component, such as solvents and/or ligands, and/or to modify the characteristics of the resultant NTF. The removal of the organic component may result in layer shrinkage of up to 50% or more, which may result in the formation of discontinuities, such as cracks, in an NTF. Discontinuities can degrade the optical and/or electrical properties of an NTF.

In order to avoid discontinuities, the thickness of a conventional NTF produced by a single solution deposition step has typically been limited to about 450 nm or less. However, in many applications, thicker NTFs are desirable, since thicker films provide various benefits, such as increased conductivity and/or electrochromic activity.

In order to provide continuous, crack-free NTFs having a thickness of greater than about 450 nm, conventional solution deposition methods rely upon the formation of multiple sublayers, e.g., multiple stacked nanocrystal films formed via multiple deposition and annealing steps. Therefore, there is a need for methods of producing continuous NTFs having thicknesses of greater than about 450 nm, using a single coating step to reduce the process complexity and cost. In one embodiment, a “continuous NTF” may have less than 1 discontinuity, such as less than 1 crack, per cm′ of surface area. In another embodiment, a “continuous NTF” may have no cracks through a linear thickness of at least 500 nm through the NTF. In other words, the NTF is at least 500 nm thick and at least 500 nm long imaginary straight line of extending in a direction from the bottom to the top of the NTF does not cross a crack in the NTF.

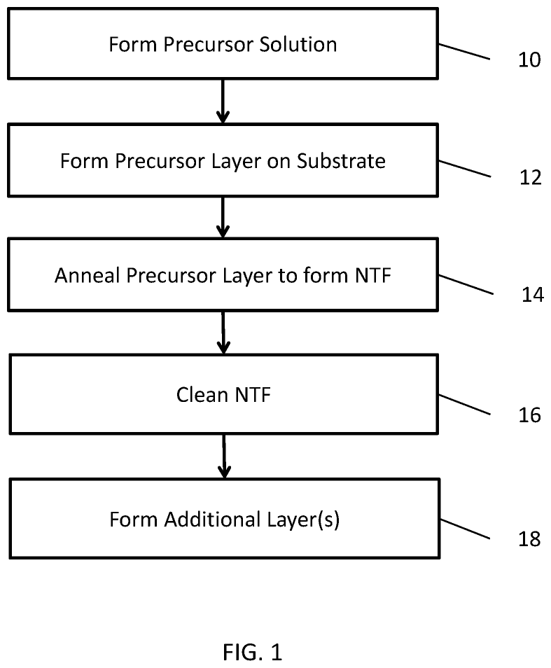

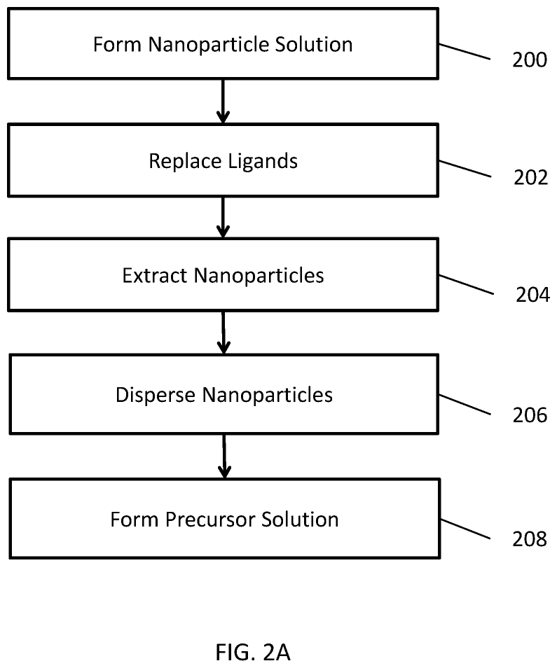

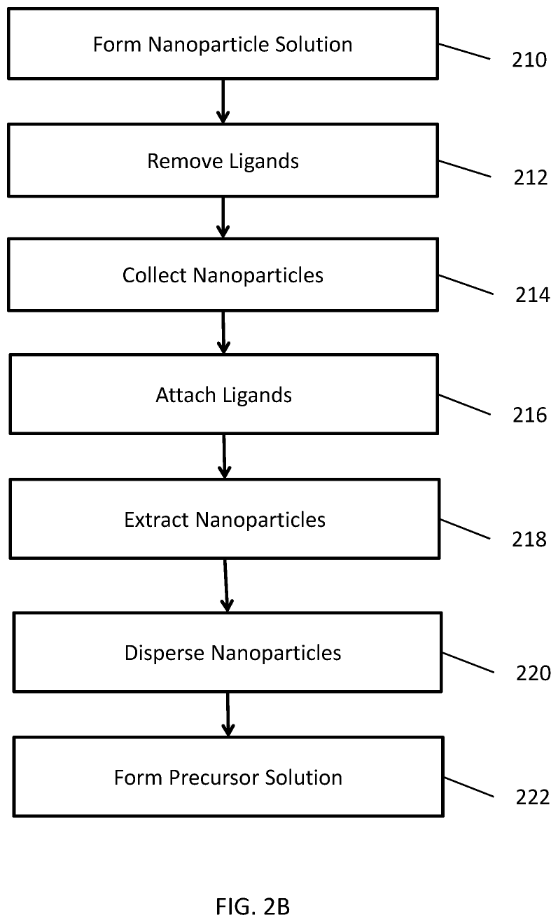

FIG. 1 is a block diagram of a method of forming a NTF, according to various embodiments of the present disclosure. Referring to FIG. 1, in step 10, the method may include forming a NTF precursor solution or mixture. In some embodiments, the precursor solution may be in the form of an ink. Methods of forming the precursor solution will be discussed in detail below with respect to FIGS. 2A and 2B.

In step 12, the method may include coating a substrate with the precursor solution to form a precursor layer on the substrate. Herein a “solution” may include compositions in which the solid component is either completely dissolved in the solvent or not completely dissolved in the solvent, such as mixtures, suspensions, colloids, or the like. The coating may be performed using any suitable coating or printing method. The substrate may be a light-transmissive substrate, such as a glass or plastic substrate.

In step 14, the method may include annealing the precursor layer to form a first NTF. In particular, step 14 may include heating the substrate at a temperature and/or for a time period sufficient to drive off an organic component of the precursor layer and/or modify the crystal structure of deposited nanoparticles. After annealing, the first NTF may have a thickness of greater than about 450 nm, such as a thickness ranging from about 475 to about 800 nm, from about 500 to about 700 nm, or from about 550 to about 650 nm.

In step 16, the method may optionally include cleaning the substrate to remove any unbound compounds from the NTF, such as an unbound portion of the structural component and/or any remaining organic materials, as discussed below.

In step 18, the method may optionally include forming one or more additional layers on the first NTF. For example, in some embodiments, step 18 may include forming a second NTF on the first NTF. The second NTF may be formed by the same deposition process as the first NTF, or may be formed by a different process. The second NTF may be formed of the same material as the first NTF, or may be form of a different material.

In some embodiments, step 18 may include forming non-crystalline layers on the first NTF, such as an electrolyte layer or other device layers, for example. Step 16 may include forming layers of an EC device.

### Precursor Solutions

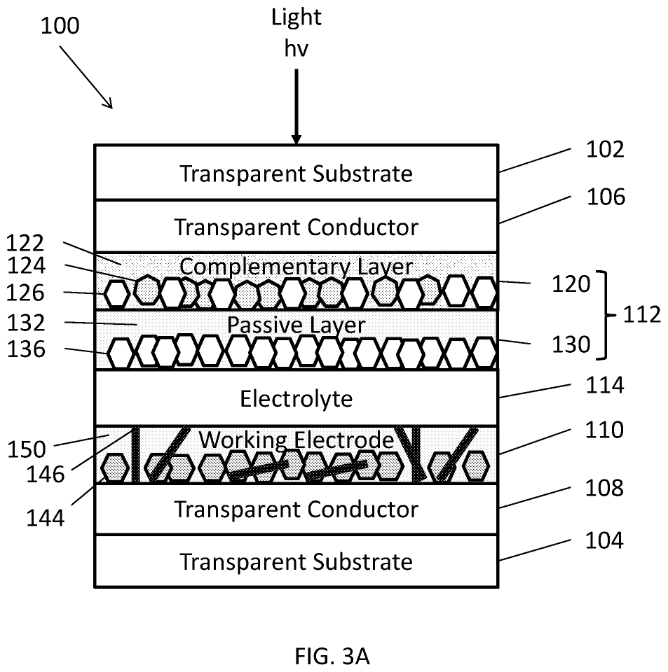

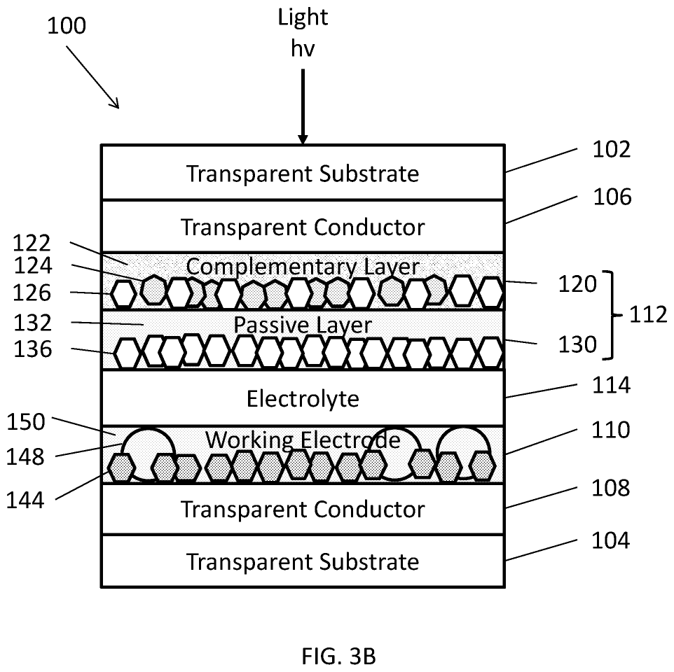

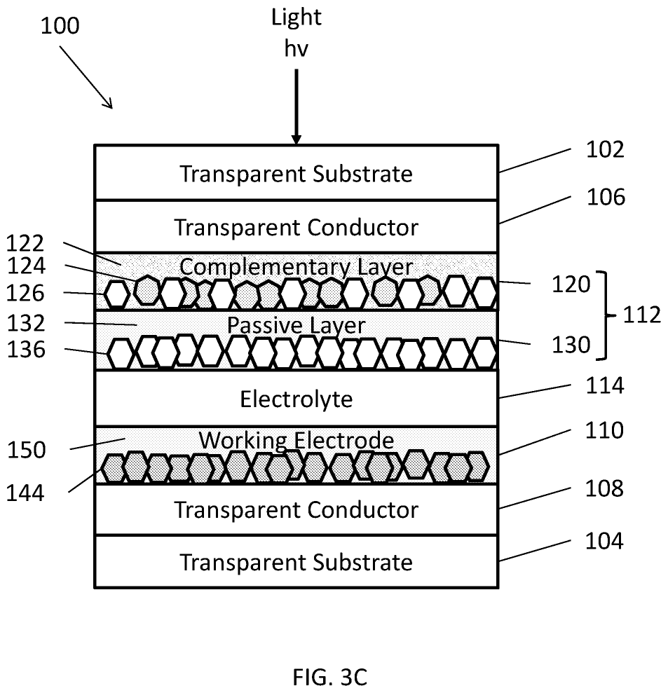

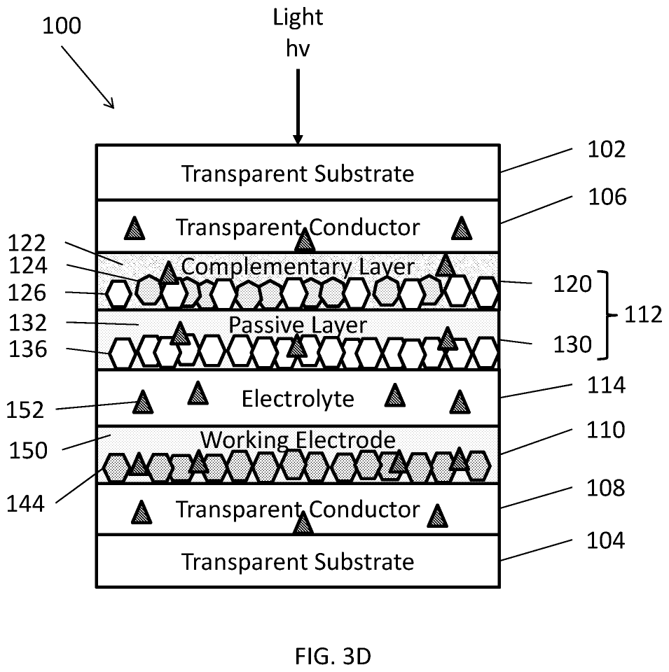

The precursor solution may be synthesized using colloidal techniques and may include metal oxide nanoparticles, an organic component and an optional additive. The metal oxide nanoparticles may include electrochromic nanoparticles. The organic component may include ligands, one or more solvents, and one or more optional additives. In some embodiments, the ligands may be bound to the nanoparticles and may operate to solubilize the nanoparticles in the solvent. The optional additive may include a structural component, which may comprise one or more conductive materials configured to prevent or reduce the formation of discontinuities, such as cracks, during annealing of a deposited precursor layer, as will be described in more detail below with respect to FIGS. 3A-3D.

In some embodiments, the precursor solution may include an inorganic content (e.g., solids content including nanoparticles and/or structural component) ranging from about 100 to about 600 mg/ml, such as from about 350 to about 650 mg/ml, or from about 450 to about 550 mg/ml. The organic component may form a remainder of the precursor solution.

### Organic Components

In various embodiments, the precursor solution may include organic components, such as organic ligands and one or more solvents. For example, the precursor solution may include any suitable organic solvent, such as dimethylbenzene (e.g., xylene), or the like.

The ligands may be bound to the surface of the nanoparticles and may operate to solubilize the nanoparticles in the solvent. In some embodiments, precursor solution may include relatively small (e.g., short) C8 or lower capping ligands (e.g., including carbon chains of 8 or fewer carbon atoms) attached to the metal oxide nanoparticles. Examples of such C8 or lower ligands include phosphonic acids, such as octylphosphonic acid or hexylphosphonic acid, and non-phosphonic acids, such as a carboxylic acid or an amine, such as octanoic acid, hexanoic acid, octyl amine, or hexyl amine.

It is believed that the use of C8 or lower capping ligands reduces the distance between deposited nanoparticles. Accordingly, NTFs formed from nanoparticles attached to C8 or lower ligands have reduced shrinkage during annealing, as compared to NTFs formed from nanoparticles bound to relatively longer C12 or higher organic ligands. Therefore, C8 or lower ligands may prevent or reduce the formation of discontinuities in the NTF during annealing, such as cracks.

### Forming Precursor Solutions

FIGS. 2A and 2B are flow diagrams illustrating methods of forming precursor solutions, as shown in step 10 of FIG. 1. The formation of the precursor solution may include a ligand exchange process to replace larger ligands (e.g., C12-C20 or higher ligands) such as oleylamine, C12 dicarboxylic acid, etc., with smaller ligands (e.g., C8 or lower ligands), such as octylphosphonic acid, hexylphosphonic acid, octanoic acid, hexanoic acid, octyl amine, hexyl amine, etc., bound to the surface of the metal oxide nanoparticles.

Referring to FIG. 2A, in step 200, the ligand exchange process method may include preparing a solution including ligand-solubilized metal oxide nanoparticles in an organic solvent, such as xylene. For example, the nanoparticles may be solubilized by C12 or higher ligands. The solution may include about 50-200 mg/ml of the nanoparticles, for example.

In step 202, the method may include adding a phosphonic acid to the solution. For example, about 1 ml of phosphonic acid may be added to 10 ml of the metal oxide solution. The resultant solution may be sonicated to replace the C12 or higher capping ligands with shorter phosphonic acid-based capping ligands. For example, the phosphonic acid solution may be sonicated for about 15-60 minutes, at about 50-75° C., in order to replace the C12 or higher capping ligands for the shorter C8 or lower phosphonic acid-based capping ligands.

In step 204, an organic solvent may then be added to the sonicated solution, and the resultant solution may be centrifuged in order to extract the ligand-exchanged nanoparticles. For example, about 15-50 ml of methanol may be added to the sonicated solution, and the resultant solution may be centrifuged about 1-10 minutes. The nanoparticles may then be extracted from the solution.

In step 206, the extracted nanoparticles may be dispersed in an organic solvent. For example, the collected nanoparticles may be dispersed in 5-20 ml of xylene.

In step 208, the method may optionally include adding other components, such as viscosity enhancers, structural components, or the like, to complete the precursor solution and/or form a precursor solution ink.

Referring to FIG. 2B, in step 210, the ligand replacement process may include preparing a solution including ligand-solubilized metal oxide nanoparticles in an organic solvent, such as xylene. The nanoparticles may be solubilized by C12 or higher ligands. The solution may include about 50-200 mg/ml of the nanoparticles.

In step 212, an organic solvent may then be added to the nanoparticle solution, and the resultant solution may be sonicated to remove existing C12 or higher ligands from the metal oxide particles. For example, 15-50 ml of methanol may be added to the solution, followed by sonication for about 15-60 minutes, at about 50-75° C., in order to remove the C12 or higher capping ligands from the nanoparticles.

In step 214, the sonicated solution may then be may be centrifuged in order to collect the nanoparticles. For example, the sonicated solution may be centrifuged for about 1-10 minutes.

In step 216, the collected nanoparticles may be dispersed in a mixture of an organic solvent and a carboxylic acid or amine-based ligand or ligand precursor composition. For example, the collected nanoparticles may be dispersed in a solution including 5-20 ml xylene and 0.5-3 ml carboxylic acid or amine-based ligand or ligand precursor composition. The resulting solution may be sonicated to replace for C8 or lower capping ligands. For example, the solution may be sonicated for about 15-60 minutes, at about 50-75° C., in order to replace the ligands.

In step 218, an organic solvent may be added to the sonicated solution, and the resulting solution may be centrifuged to extract the ligand-exchanged nanoparticles. For example, 15-50 ml of methanol may be added to the sonicated solution, and the resultant solution may be centrifuged for about 1-10 minutes. The nanoparticles may then be collected

In step 220, the nanoparticles may be dispersed in an organic solvent. For example, the nanoparticles may be dispersed in 5-20 ml of xylene.

In step 222, the method may optionally include adding other components, such as viscosity enhancers, structural components, or the like, to complete the precursor solution and/or form a precursor solution ink.

### Nanoparticles

As used herein, the term “nanoparticle” includes any suitable nanoparticle shape, such as a sphere, rod (e.g., nanorod or nanowire), a three dimensional polygon and/or an irregular shape. The precursor solution may include a single type of metal oxide nanoparticle, or mixtures of different types of metal oxide nanoparticles. The metal oxide nanoparticles may include crystalline, doped or un-doped, transition metal oxides. The metal oxide nanoparticles may be spherical and may have an average particle size ranging from about 1 to about 10 nm, such as from about 1.5 to about 5 nm, or from about 2 to about 3 nm. While spherical metal oxide nanoparticles may provide a wide level of porosity, which may enhance the switching kinetics, non-spherical metal oxide nanoparticles may also be used. In some embodiments, the metal oxide nanoparticles may be coated is an organic compound, such as an organic ligand.

For example, the metal oxide nanoparticles may be formed of a transparent conducting oxide (TCO) material, such as indium tin oxide (ITO), fluorine doped tin oxide (FTO), Nb—TiO₂, Al—ZnO zinc oxide, or the like, or mixtures thereof.

In some embodiments, the metal oxide nanoparticles may include electrochromic nanoparticles that vary in optical transmission according to an applied electrical bias. For example, suitable electrochromic materials may include any transition metal oxide which can be reduced and has multiple oxidation states, such as niobium oxide, tungsten oxide, molybdenum oxide, vanadium oxide, titanium oxide, and mixtures of two or more thereof. For example, the electrochromic nanoparticles may include ternary compositions of the type AₓM_{z}O_{y}, where M represents a transition metal ion species in at least one transition metal oxide, and A represents at least one dopant. In some embodiments, the electrochromic nanoparticles may include doped or undoped WO₃₋ₓ, CsₓWO₃₋ₓ, and/or NbOₓ, nanoparticles, where 0≤x≤0.33, such as 0≤x≤0.1. Thus, when x=0, WO₃₋ₓ is WO₃.

In some embodiments, the metal oxide nanoparticles may include a first dopant species selected from cesium, rubidium, and lanthanides (e.g., cerium, lanthanum, praseodymium, neodymium, promethium, samarium, europium, gadolinium, terbium, dysprosium, holmium, erbium, thulium, ytterbium, and lutetium). In some embodiments, the metal oxide nanoparticles may include a second dopant species, which may be an intercalation ion species selected from lanthanides (e.g., cerium, lanthanum, praseodymium, neodymium, promethium, samarium, europium, gadolinium, terbium, dysprosium, holmium, erbium, thulium, ytterbium, and lutetium), alkali metals (e.g., lithium, sodium, potassium, rubidium, and cesium), and alkali earth metals (e.g., beryllium, magnesium, calcium, strontium, and barium). In other embodiments, the second dopant species may include a charged proton species.

In some embodiments, the metal oxide nanoparticles may include complementary (e.g., color balancing) nanoparticles that may complementary materials that are transparent to NIR radiation, but which may be oxidized in response to application of a bias, thereby causing absorption of visible light radiation. Examples of such complementary materials may include nickel oxide (e.g., NiOₓ, where 1≤x≤1.5, such as NiO), Cr₂O₃, MnO₂, FeO₂, CoO₂, RhO₂, or IrO₂, or mixtures thereof.

In some embodiments, the metal oxide nanoparticles may include passive nanoparticles comprising at least one passive material that is optically transparent to both visible and NIR radiation during the applied biases. Examples of passive materials may include CeO₂, CeVO₂, TiO₂, indium tin oxide, indium oxide, tin oxide, manganese or antimony doped tin oxide, aluminum doped zinc oxide, zinc oxide, gallium zinc oxide, indium gallium zinc oxide, molybdenum doped indium oxide, Fe₂O₃, V₂O₅, or mixtures thereof.

In various embodiments, the nanoparticles may form from about 10 to about 99 vol. % of the inorganic content of the precursor solution, such as from about 30 to about 90 vol. %, or from about 50 to about 80 vol. % of the inorganic content.

### Structural Component

In some embodiments, the method may also include adding an optional structural component to the solution. The structural component may include one or more materials configured to prevent or reduce the formation of discontinuities in the NTF, such as cracks, during annealing. For example, the structural component may be configured to reduce shrinkage during annealing and/or support nanoparticles during annealing. The structural component (146, 148, 150) shown in FIGS. 3A-3D may include one or more of a scaffolding agent 146, oversized nanoparticles 148, a matrix 150, or any combination thereof. The structural components (146, 148, 150) are illustrated generically as element 152 in FIG. 3D.

In various embodiments, the inorganic content of the precursor solution may comprise from about 1 to about 90 vol. % of the structural component, such as from about 10 to about 70 vol. % or from about 20 to about 50 vol. %, based on the total volume of the inorganic content. For example, the inorganic content of the precursor solution may comprise from about 1 to about 90 vol. % of the scaffolding agent and/or oversized nanoparticles, such as from about 10 to about 70 vol. %, or from about 20 to about 50 vol. %, based on the total volume of the inorganic content. In some embodiments, the inorganic content of the precursor solution may comprise from about 1 to about 90 vol. % of the matrix, such as from about 10 to about 70 vol. %, or from about 20 to about 50 vol. %, based on the total volume of the inorganic content. In some embodiments, the inorganic content of the precursor solution may comprise from about 1 to about 90 vol. % of the combination of the matrix and one or more of the scaffolding agent and/or oversized nanoparticles, such as from about 10 to about 70 vol. %, or from about 20 to about 50 vol. %, based on the total volume of the inorganic content.

The scaffolding agent 146 may include one or more conductive materials configured to cooperate with one another to hold the metal oxide nanoparticles in place during annealing. The scaffolding agent may include elongated nanoparticles (e.g., nanoparticles having an average aspect ratio of at least 1:5, such as of at least 1:10), or an aspect ratio that is at least two times greater than the aspect ratio of the metal oxide nanoparticles. For example, the scaffolding agent may include carbon nanotubes (e.g., electrically conductive metallic carbon nanotubes), metal nanowires, inorganic, electrically conductive metal oxide or metal nitride nano-rods (e.g., nanocrystal nano-rods), or any combinations thereof. The elongated nanoparticles may have an average length ranging from about 10 to about 100 nm, such as from about 15 to about 50 nm, or from about 20 to about 40 nm. In one embodiment, the elongated nanoparticles (e.g., nanotubes or nano-rods) have an average length that is at least two times greater, such as at least five or ten times greater, for example ten to fifty times greater than the average size (e.g., width or diameter for spherical nanoparticles) of the electrochromic metal oxide nanoparticles. In some embodiments, the scaffolding agent may include optically transparent nano-rods, such as tungsten oxide (e.g., WO₃) nano-rods.

The oversized nanoparticles may be configured to reduce the amount of shrinkage during annealing of the NTF. The oversized nanoparticles may be formed of any of the metal oxide materials described above, such as tungsten oxide, and are preferably optically transparent and electrically conductive. The oversized nanoparticles may have an average particle size ranging from about 20 to about 100 nm, such as from about 25 to about 50 nm, or from about 30 to about 40 nm. In one embodiment, the oversized nanoparticles have an average size (e.g., width or diameter for spherical nanoparticles) that is at least five times greater, such as at least ten times greater, for example ten to fifty times greater than the average size (e.g., width diameter for spherical nanoparticles) of the electrochromic metal oxide nanoparticles.

The matrix may be configured to form an interconnected supporting matrix around the metal oxide nanoparticles, and reduce the amount of shrinkage during annealing of the NTF. The matrix may include a lithium metal oxide, such as LiNbO₃ (lithium niobate), Li₂WO₄ (lithium tungstate), LiTaO₃ (lithium tantalite), precursors thereof, combinations thereof, or the like.

In some embodiments, the matrix may comprise a lithium salt material, which may also be also referred to herein as a flux material. For example, the matrix may comprise a Li-rich anti-perovskite (LiRAP) material, in addition to, or in place of the above described lithium metal oxide matrix materials. In one embodiment, the structural component comprises a matrix comprising a combination of the LiRAP material and the lithium metal oxide, having a volume ranging from about 1% to about 99% of the LiRAP material and from about 99% to about 1% of the lithium metal oxide.

An anti-perovskite is a compound having a crystal structure like a conventional perovskite but with the unit cell having the positive and negative species reversed. In a perovskite structure, the unit cell is face centered cubic. The negative atoms normally sit on the face centers and positive ions sit in the corners. Additionally, there will be a third type of atom, a cation, in the center of the cubic unit cell. In an antiperovskite structure, the locations of cations and anions are reversed. In the antiperovskite structure, of the type described herein, oxygen or sulfur atoms, for example, reside at centers of the unit cell, halogen atoms sit at corners of the unit cell, and lithium ions reside in the face centers of the unit cell. It is believed that the face centered species may be the most mobile species in the unit cell.

According to various embodiments, the matrix may include a LiRAP material having the formula Li₃OX, where X may be a halogen or a combination of halogens. For example, X may be F, Cl, Br, I, or any combination thereof. In some embodiments, the LiRAP material may be Li₃OI. In some embodiments, the LiRAP material may also include one or more dopant species. In some embodiments, the LiRAP material may be aliovalently doped by replacing a first anion in the base structure with a second anion that has a valence more positive than that of the first atom.

The LiRAP material may be formed from constituent lithium salts. For example, the LiRAP material may be formed from an oxygen-containing lithium salt and a halogen salt of lithium. Examples of the oxygen-containing lithium salt include lithium hydroxide (LiOH) lithium acetate (C₂H₃LiO₂), lithium carbonate (Li₂CO₃), lithium oxide (Li₂O), lithium perchlorate (LiClO₄), lithium nitrate (LiNO₃), or any combination thereof. Examples of the halogen salt of lithium include lithium chloride (LiCl), lithium bromide (LiBr), lithium fluoride (LiF), lithium iodide (LiI), or any combination thereof. In some embodiments, the LiRAP material may be formed from LiOH and LiI.

In some embodiments, the structural component may comprise any two or all three of scaffold material, oversized nanoparticles and/or matrix material.

### EC Devices

FIG. 3A is schematic view of an EC device 100, according to various embodiments of the present disclosure. It should be noted that the thickness of the layers and/or size of the components of the devices in FIG. 3A are not drawn to scale or in actual proportion to one another other, but rather are shown as representations. One or more layers of the EC device 100 may be formed using the methods and materials described above, with regard to FIG. 1. As such, the materials of the EC device are not described in detail below.

Referring to FIG. 3A, the EC device 100 may include opposing first and second substrates 102, 104. The first and second substrates 102, 104 may be transparent substrates, such as substrates formed of optically transparent glass or plastic. However, in some embodiments, the substrates 102, 104 may be omitted. For example, the EC device 100 may refer to a coating formed of the various layers of FIG. 1 that are disposed between the substrates 102, 104.

First and second transparent conductors 106, 108 may be respectively disposed on the first and second substrates 102, 104. A counter electrode 112 may be disposed on the first transparent conductor 106, and a working electrode 110 may be disposed on the second transparent conductor 108. An electrolyte 114 may be disposed on between the working electrode 110 and the counter electrode 112.

The first and second transparent conductors 106, 108 may be formed from transparent conducting films fabricated using inorganic and/or organic materials. For example, the transparent conductors 106, 108 may include inorganic films of transparent conducting oxide (TCO) materials, such as indium tin oxide (ITO) or fluorine doped tin oxide (FTO). In other examples, organic films of transparent conductors 106, 108 may include graphene and/or various polymers.

### Electrodes

The counter electrode 112 should be capable of storing enough charge to sufficiently balance the charge needed to cause visible tinting electrochromic nanoparticles 144 of the working electrode 110. In various embodiments, the counter electrode 112 may be formed as a conventional, single component film, a multilayer film, a nanostructured film, or a nanocomposite layer.

In some embodiments, the counter electrode 112 may include a complementary layer 120 and a passive layer 130. The complementary layer 120 may include metal oxide nanoparticles disposed in a metal oxide matrix 122. In various embodiments, the complementary layer 120 may optionally include a flux material, as discussed in detail below with regard to the passive layer 130.

The matrix 122 may be formed of a lithium metal oxide. For example, the matrix 122 may be formed of LiNbO₃ (lithium niobate), Li₂WO₄ (lithium tungstate), LiTaO₃ (lithium tantalite), combinations thereof, or the like.

The nanoparticles may include complementary nanoparticles 124 comprising at least one complementary (e.g., color balancing) material, which may be transparent to NIR radiation, but which may be oxidized in response to application of a bias, thereby causing absorption of visible light radiation. Examples of such complementary counter electrode materials may include nickel oxide (e.g., NiOₓ, where 1≤x≤1.5, such as NiO), Cr₂O₃, MnO₂, FeO₂, CoO₂, RhO₂, or IrO₂.

In some embodiments, the complementary layer 120 may include passive nanoparticles 126 comprising at least one passive material that is optically transparent to both visible and NIR radiation during the applied biases. The passive nanoparticles 126 may operate as conductivity enhancer.

Examples of passive nanoparticles 126 may include CeO₂, CeVO₂, TiO₂, indium tin oxide, indium oxide, tin oxide, manganese or antimony doped tin oxide, aluminum doped zinc oxide, zinc oxide, gallium zinc oxide, indium gallium zinc oxide, molybdenum doped indium oxide, Fe₂O₃, V₂O₅, or mixtures thereof.

In some embodiments, the complementary layer 120 may include NiO complementary nanoparticles 124 and In₂O₃ passive nanoparticles 126 disposed in a LiNbO₃ matrix 122. The complementary layer 120 may also optionally comprise a flux material comprising a LiRAP material, as described below.

The passive layer 130 may include mixture of a flux material 132 and passive nanoparticles 136. Herein, when a flux material is included in a component of the EC device 100, the flux material may form a mixture with other elements of the component, such as nanoparticles, may form a coating on such nanoparticles (e.g., a core-shell structure), and/or may form a matrix in which nanoparticles are disposed. In some embodiments, the flux material and nanoparticles may be impregnated in a metal oxide matrix of a corresponding component.

The flux material 132 may comprise any suitable material that melts at a temperature that is lower than a sintering, crystallization, and/or phase transition temperature of metal oxide nanoparticles included in the EC device 100. For, example, the flux material 132 may have a melting temperature ranging from about 25° C. to about 500° C., such as from about 50° C. to about 450° C., or from about 100° C. to about 400° C. For example, the flux material 132 may be configured to melt when the EC device 100 is heated, such as during a tempering or heat-bending process applied to the EC device 100.

In some embodiments, the flux material 132 may comprise a lithium salt material. For example, the flux material 132 may comprise a Li-rich anti-perovskite (LiRAP) material.

The passive nanoparticles 136 may comprise at least one passive material that is optically transparent to both visible and NIR radiation during the applied biases. Examples of such passive counter electrode materials may include CeO₂, CeVO₄, TiO₂, indium tin oxide (ITO), In₂O₃ (Indium(III) oxide), SnO₂ (tin(IV) dioxide), manganese or antimony doped tin oxide, aluminum doped zinc oxide, ZnO (zinc oxide), gallium zinc oxide, indium gallium zinc oxide (IGZO), molybdenum doped indium oxide, Fe₂O₃, V₂O₅, or mixtures thereof.

In some embodiments, passive layer 130 may include a mixture of CeO₂ and In₂O₃ passive nanoparticles 136 and a LiRAP flux material 132. The passive layer 130 may also optionally include a LiNbO₃ matrix (not shown) in which the passive nanoparticles 136 and the flux material 132 are disposed.

In various embodiments, the working electrode 110 may include doped or undoped electrochromic metal oxide nanoparticles 144 and at least one structural component (146, 148, 150). In the embodiment of FIG. 3A, the structural component of the working electrode 110 includes the combination of the scaffold material 146 and the matrix 150. The matrix 150 may include a flux material (such as LiRAP) and/or a lithium metal oxide matrix (not shown) that may include any of the materials as described above with respect to the matrix 122.

In one embodiment, the matrix 150 may be layer that surrounds the nanoparticles 144 and the scaffold material 146 may be nanotubes or nanowires which are positioned uniaxially or randomly in the matrix 150 between the nanoparticles. In another embodiment, either the matrix 150 or the scaffold material 146 may be omitted from the working electrode 110.

FIG. 3B illustrates an alternative embodiment of the EC device 100 in which the structural component of the working electrode 110 includes the combination of the oversized nanoparticles 148 and the matrix 150. In another embodiment, either the matrix 150 or the oversized nanoparticles 148 may be omitted from the working electrode 110.

FIG. 3C illustrates an alternative embodiment of the EC device 100 in which the structural component of the working electrode 110 includes just the matrix 150. In other embodiments, the matrix 150 may also be omitted from the EC device in which no structural components are present.

While the exemplary embodiment described above forms the working electrode 110 of the EC device 100 using the method of FIG. 1, in another embodiment, the method of FIG. 1 can be used to form the counter electrode 112 or both the working and counter electrodes of the EC device.

FIG. 3D illustrates an alternative embodiment of the EC device 100. Referring to FIG. 3D, the EC device may include a structural component 152 disposed in one or more of layers 106, 108, 110, 112, 114. In particular, the structural component 152 may include any of the structural components described above, such as a scaffolding agent, oversized nanoparticles, a matrix, or any combination thereof.

The foregoing description of the invention has been presented for purposes of illustration and description. It is not intended to be exhaustive or to limit the invention to the precise form disclosed, and modifications and variations are possible in light of the above teachings or may be acquired from practice of the invention. The description was chosen in order to explain the principles of the invention and its practical application. It is intended that the scope of the invention be defined by the claims appended hereto, and their equivalents.

1. An electrochromic (EC) device comprising:
a first substrate;
a second substrate;
a transparent first conductor disposed between the first and the second substrates;
a transparent second conductor disposed between the first and the second substrates;
a working electrode disposed between the first and the second conductors;
a counter electrode disposed between the working electrode and the second conductor, the counter electrode comprising nickel oxide nanoparticles having an average particle size ranging from about 1 nm to less than 5 nm; and
an electrolyte disposed between the working electrode and the counter electrode.

2. The EC device of claim 1, wherein the nickel oxide nanoparticles comprise NiOₓ, where 1≤x≤1.5.

3. The EC device of claim 2, wherein the nickel oxide nanoparticles comprise NiO.

4. The EC device of claim 1, wherein the nickel oxide nanoparticles have an average particle size ranging from about 2 nm to about 3 nm.

5. The EC device of claim 1, wherein the nickel oxide nanoparticles comprise complementary nanoparticles.

6. The EC device of claim 5, wherein the counter electrode further comprises passive nanoparticles comprising CeO₂, CeVO₄, TiO₂, indium tin oxide (ITO), In₂O₃ (Indium(III) oxide), SnO₂ (tin(IV) dioxide), manganese or antimony doped tin oxide, aluminum doped zinc oxide, ZnO (zinc oxide), gallium zinc oxide, indium gallium zinc oxide (IGZO), molybdenum doped indium oxide, Fe₂O₃, V₂O₅, or mixtures thereof.

7. The EC device of claim 6, wherein the counter electrode comprises:
a complementary layer comprising the complementary nanoparticles and the passive nanoparticles disposed in a metal oxide matrix; and
a passive layer disposed between the complementary layer and the electrolyte.

8. The EC device of claim 7, wherein the matrix comprises LiNbO₃ (lithium niobate), Li₂WO₄ (lithium tungstate), LiTaO₃ (lithium tantalite), or mixtures thereof.

9. The EC device of claim 7, wherein the passive layer comprises passive nanoparticles disposed in a flux material.

10. The EC device of claim 1, wherein at least one the counter electrode, the working electrode, the first transparent conductor, the second transparent conductor, or the electrolyte comprises a structural component configured to at least one of reduce shrinkage during annealing or support nanoparticles during annealing of the EC device.

11. The EC device of claim 11, wherein the structural component comprises a scaffolding agent, oversized nanoparticles, a matrix, or any combination thereof.
